(19) United States
(12) Patent Application Publication
(10) Pub. No.: US 2007/0005492 A1
(43) Pub. Date: Jan. 4, 2007

(54) Electronic settlement method by conditional trade

(76) Inventor: Min-Suh Kim, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 10/557,858

(22) PCT Filed: May 13, 2004
(86) PCT No.: PCT/KR04/01117

§ 371 Date: Jan. 9, 2006

(30) Foreign Application Priority Data
May 20, 2003 (KR) 10-2003-0031843

(51) Int. Cl. G06Q 40/00

(52) U.S. Cl. 705/39

(57) ABSTRACT

Disclosed herein is a method and electronic payment server for performing electronic payment for conditional transactions. The method includes the step of taking member registration from a user and an affiliate shop; the step of being notified of a transaction request by a conditional transaction subscription processor, and notifying a user's mobile communication terminal of details of the request; the step of payment for a transaction being requested by the user and the affiliate shop; the step of generating an electronic slip and transmitting the electronic slip to a user's mobile communication terminal; the step of receiving an approved electronic slip from the user's mobile communication terminal; the step of performing transfer of payments by requesting the transfer of payments from user's transfer account to the affiliate shop's deposit account; and the step of notifying the user and the affiliate shop of completion of the payment.

### TECHNICAL FIELD

The present invention relates to a method for allowing a transaction to occur based on a specific condition for the occurrence of the transaction and performing electronic payment between a user's mobile communication terminal and an electronic payment server, in which a user or an affiliate shop is provided with a conditional transaction subscription processor so as to allow the transaction to occur based on the condition for the occurrence of the transaction, and the electronic server.

### BACKGROUND ART

In general, a commercial transaction is conducted by delivering commodities to trade the commodities and paying the price for the commodities. With the development of wired and wireless communication networks and the Internet, such a commercial transaction has evolved to be conducted on-line, and thus, a concept of electronic commerce (e-commerce) has been derived therefrom.

The case where a purchaser purchases a commodity on the Internet and a payment is made by inputting the credit information of a purchaser and the expiration date of the purchaser's credit card, and the case of home shopping where payment is made by calling a corresponding home shopping company and informing the home shopping company of the credit information of a purchaser and the expiration date of the purchaser's credit card, can be cited as representative examples of e-commerce.

Furthermore, with the recent development of information and communication technology, the function of a mobile communication terminal is improved, so that various payment methods using a mobile communication terminal have been proposed. As for the payment methods using a mobile communication terminal, various methods (Korean Appl. No. 10-1999-0063144, and Korean Appl. No. 10-2001-0066370 filed by the present applicant) have been proposed.

The conventional electronic payment methods using a mobile communication terminal have a flow of electronic payment in which electronic payment is performed in such a way that a customer and an affiliate shop, that is, commercial transaction parties, make a contract for a specific commercial transaction on-line or off-line and request payment for the corresponding transaction from an electronic payment server.

Accordingly, in the case where a transaction request and the completion of a transaction are performed in real time based on a specific condition, such as an inventory of commodities, a customer must always monitor the inventory of commodities and request the purchase of the commodity from a corresponding commodity shop whenever the inventory of commodities is insufficient. In particular, there is additional inconvenience in that separate payment must be made after the purchase request.

### DESCRIPTION OF DRAWINGS

FIG. 1 is a view showing the state of performing payment following the occurrence of a conditional transaction in accordance with the present invention;

FIG. 2 is an internal configuration block diagram of an electronic payment server according to the present invention;

FIG. 3 is a view showing an example of an electronic slip that the electronic payment server transmits to a user's mobile communication terminal;

FIG. 4 is a view showing a flow of electronic payment when a conditional transaction subscription processor exists under the user's management; and

FIG. 5 is a view showing a flow of electronic payment when a conditional transaction subscription processor exists under the affiliate shop's management

### DESCRIPTION OF REFERENCE CHARACTERS OF PRINCIPAL ELEMENTS

S402: input of condition for occurrence of transaction

S404: notification of transaction request

S406: notification of details of transaction request

S408: contact for transaction

S410: payment request

S412: transmission of electronic slip

S414: return of approved electronic slip

S416: instruction to transfer

S418: notification of transfer completion

S420b: notification of transfer completion

Disclosure

Technical Problem

Accordingly, the present invention has been made keeping in mind the above problems occurring in the prior art, and aims to solve the below objects by allowing a transaction to occur based on a specific condition for the occurrence of the transaction, and integrally performing payment related to the transaction using a mobile communication terminal.

First, when a user or an affiliate shop wants to perform a transaction based on a specific transaction condition, the user or affiliate shop requested the transaction from a sales shop while frequently monitoring whether the corresponding condition had occurred in the past, but the present invention aims at allowing a transaction to occur by automatically notifying the user or affiliate shop of the occurrence of a specific condition when the condition occurs.

Second, after the conditional transaction has been performed, corresponding payment is automatically made using the user's mobile communication terminal in an electronic slip manner, so that simplicity in payment for the conditional transaction is sought.

Technical Solution

In order to accomplish the above object, the method of the present invention includes the member registration step of taking member registration from a user and an affiliate shop who want to make electronic payment; the conditional transaction subscription notification step of being notified of a transaction request by a conditional transaction subscription processor to which a condition for occurrence of a transaction is input, and notifying a user's mobile communication terminal of details of the transaction request; the conditional transaction payment request reception step of payment for a transaction being requested by the user, which has been notified of the transaction request, and the affiliate shop, who has performed the transaction; the electronic slip transmission step of generating an electronic slip, including a transaction detail item for the requested transaction, a signature item for approval, and a transfer account selection item for payment, and transmitting the electronic slip to the user's mobile communication terminal; the approved electronic slip reception step of receiving an approved electronic slip, including a signature item, to which an approval indication is affixed, and a transfer account item, on which a transfer account used for payment is indicated, from the user's mobile communication terminal; the payment step of performing transfer of payments by requesting the transfer of payments from the user's transfer account indicated on the transfer account item of the approved electronic slip to the affiliate shop's deposit account from a financial institution's server; and the payment completion notification step of notifying the user and the affiliate shop of completion of the payment, together with payment details, after the completion of the transfer.

Best Mode

A preferred embodiment of the present invention is described in detail with reference to the accompanying drawings below.

A user's mobile communication terminal 110, a conditional transaction subscription processor 120, an affiliate shop's terminal 130, and an electronic payment server 150 are connected via wired/wireless communication networks 140, so that they exchange transaction details and data necessary for payment. In the above description, the wired/wireless communication network 140 includes not only a Public Switched Telephone Network (PSTN) but also a wireless communication network connected to the PSTN, and refers to all wired and wireless communication networks, including the Internet, which can perform data communication.

The user's mobile communication terminal 110 refers to a personal portable terminal that a user is using, such as a cellular phone, a Personal Communication System (PCS) phone, or a Personal Digital Assistant (PDA), and the affiliate shop 130 refers to a Personal Computer (PC), a wireless terminal or an affiliate shop management server that can exchange payment-related information with the electronic payment server 150 via the Internet or a wired/wireless communication network.

The electronic payment server 150 is a server that performs electronic payment through an account transfer method or the like accompanying a commodity transaction in accordance with the present invention.

The conditional transaction subscription processor 120 is a module that monitors whether a specific condition for the occurrence of a transaction preset by the user or the affiliate shop has been fulfilled, and notifies the user or the affiliate shop of a transaction request when the corresponding condition for the occurrence of the transaction is fulfilled. Accordingly, the conditional transaction subscription server 120 is a device equipped with sensors capable of detecting the amount of inventory and has a hardware form in the case where a function of requesting a transaction depending on the amount of inventory is required to be performed, or is a program having an algorithm for checking transaction-related numerical values on the Internet in real time and has a software form installed in the affiliate shop's terminal (server) in the case where a function of requesting a transaction using specific transaction numerical values is required to be performed, as in stock trading or foreign exchange trading.

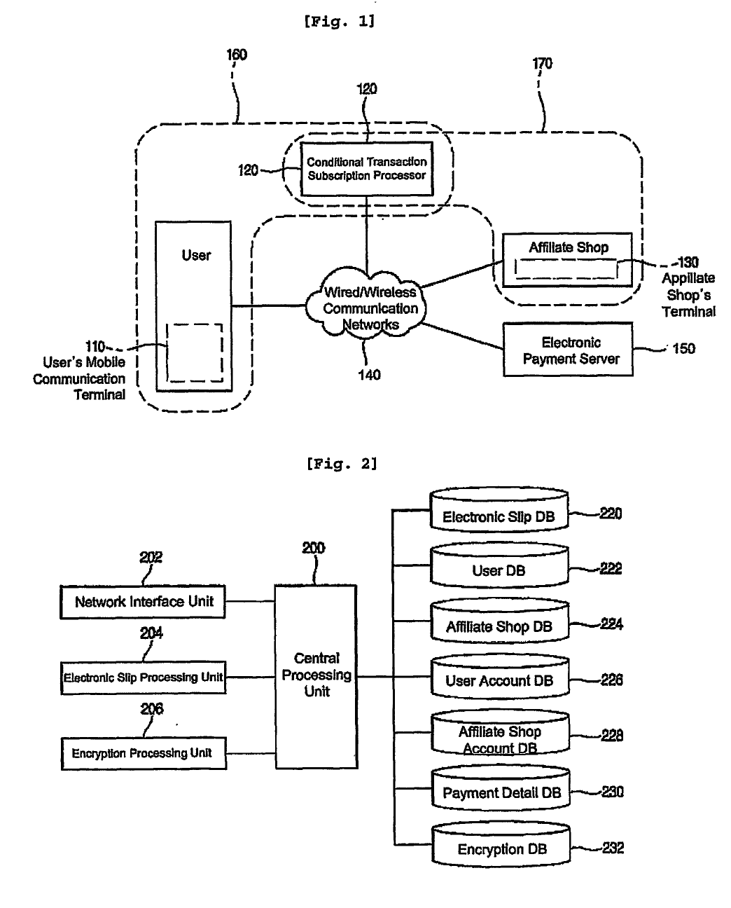

Based on FIG. 1, the practice flow of the present invention is described in brief.

Examples, in which conditional transaction subscriptions are made and transactions are concluded in accordance with the present invention, may be divided into two types. The first one is the case where the conditional transaction subscription processor performing a conditional transaction subscription exists in a user management domain 160, and the second one is the case where a conditional transaction subscription is performed within an affiliate shop management domain 170.

The first example, that is, the case where the conditional transaction subscription processor performing a conditional transaction subscription exists in a user management domain 160, refers to the case where the conditional transaction subscription processor monitors an inventory of a specific kind of commodities and makes a transaction request for the commodities when a specific condition for the occurrence of a transaction is fulfilled.

For this purpose, the user 110 presets a specific condition for the occurrence of a transaction in the conditional transaction subscription processor 120. The conditional transaction subscription processor 120, in which the specific condition for the occurrence of a transaction is preset, monitors an inventory of a specific kind of commodities in real time using inventory sensors and requests a transaction from the electronic payment server 150 when the condition for the occurrence of a transaction is fulfilled. The electronic payment server 150 completes the transaction between the user 110 and the affiliate shop 130 by notifying the user's mobile communication terminal 110 of the occurrence of the transaction request. When the transaction is completed, payment is performed by the user using an electronic slip and payments are transferred to the affiliate shop through account transfer or the like, thus completing the payment.

Meanwhile, the second example, that is, the case where the conditional transaction subscription processor exists within an affiliate shop management domain, refers to, for example, the case where the conditional transaction subscription processor 120 monitors the market price of stocks and makes a transaction request for the stocks when a specific condition is fulfilled.

For this purpose, the user 110 accesses an affiliate shop's website and inputs a specific condition for the occurrence of a transaction to the conditional transaction subscription processor 120. The conditional transaction subscription processor 120, which has received the specific condition for the occurrence of a transaction, monitors the current price of a stock or the current rate of foreign exchange using search-browsing and requests a transaction from the electronic payment server 150 when the input specific condition is fulfilled. The electronic payment server 150 notifies the user 110 of the occurrence of the transaction request and completes payment using an electronic slip when an approval for the transaction is made.

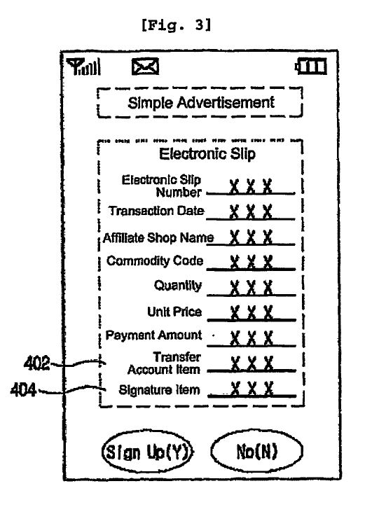

FIG. 2 is a block diagram showing the internal configuration of an electronic payment server for performing electronic payment in accordance with the present invention.

A network interface unit 202 includes wired/wireless network interface modules and functions to interface with external networks. The wired network interface module may be a module capable of supporting the Transmission Control Protocol/Internet Protocol (TCP/IP) network protocol to interface with the Internet, or a module capable of supporting interface with a PSTN. The wireless network interface module functions to support interface with a wireless mobile communication network. Through such a network interface unit, the electronic payment server can exchange required data with the terminals of each affiliate shop and each user. In the meantime, the network interface unit 202 supports interface with a satellite communication network, such as a Global Positioning System (GPS), if necessary, as well as interface with the wired/wireless networks, thus communicating with the affiliate shop and the user.

An electronic slip processing unit 204 functions to generate details related to corresponding payment in the form of an electronic slip, to transmit the electronic slip to the user, and to store the details of the corresponding electronic slip in an electronic slip database, when receiving a payment request for a specific transaction from the user. Further, when an approved electronic slip, in which a signature is affixed to the received electronic slip, is received from the user's mobile communication terminal, the electronic slip processing unit retrieves the a corresponding user's electronic signature from a user database and then determines whether the signature on the received approved electronic slip is a genuine electronic correct.

In the meantime, the above electronic slip is an electronic document for providing the safety and convenience of electronic payment based on a transaction, and is generated by the electronic slip processing unit whenever a transaction occurs and then transmitted to the user. The electronic slip includes a transaction detail item, containing a transaction date, transaction parties, transaction details, a transaction amount, etc., a transfer account selection item, and a signature item. The transfer account selection item is used to allow the user to select an account to be used for payment, and the signature item is used to allow an approval indication, which indicates that the received electronic slip details are correct, to be affixed thereto. In this case, the approval indication can be implemented in such a way that the user inputs the number of the received electronic slip, or inserts the electronic signature stored in the user's mobile communication terminal as the approval indication.

Therefore, the user transmits an approved electronic slip, which is generated by receiving the electronic slip, selecting a transfer account to be used for a transfer from a transfer account list in the transfer account selection item of the corresponding electronic slip and affixing a signature to the electronic slip as an approval indication for the transaction details, to the electronic payment server.

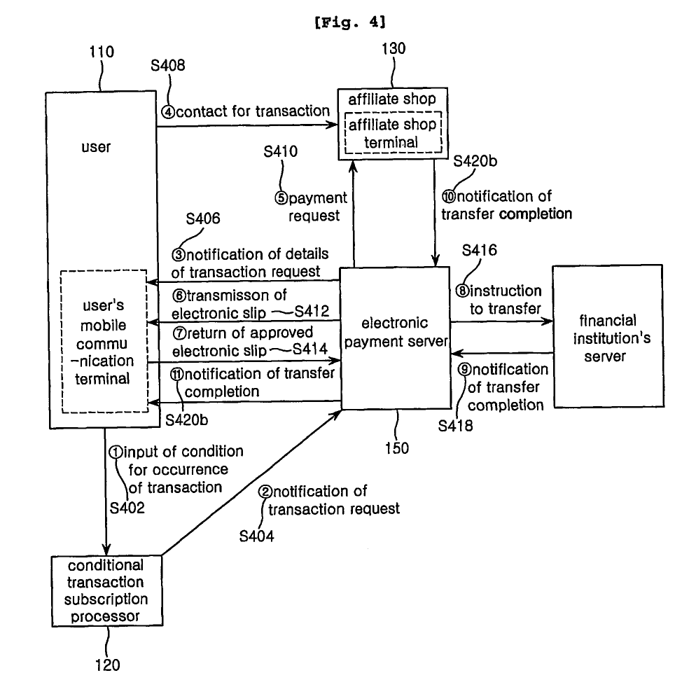

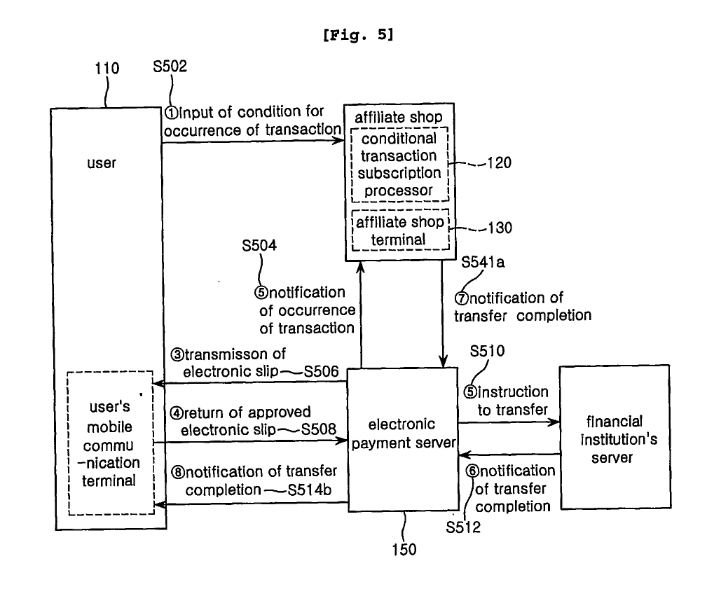

In the meantime, the electronic slip may include predetermined advertisement contents, and an embodiment of such an electronic slip is shown in FIG. 4. A detailed embodiment of the electronic slip is described in detail in Korean Appl. No. 10-2001-0066370 filed by the present applicant, so that a detailed description thereof is omitted. However, the present invention is characterized in that the electronic slip of the present invention additionally includes a signature item 404 and a transfer account item 402, while the conventional electronic slip disclosed in Korean Pat. Appl. No. 10-2001-0066370 does not include a signature item or a transfer account selection item.

An encryption processing unit 206 functions to encrypt and decrypt transaction details and an electronic slip number depending on a predetermined encryption algorithm. That is, the encryption processing unit 206 performs a function of transmitting the encrypted electronic slip to the user's mobile communication terminal, and decrypting an approved electronic slip received from the user's mobile communication terminal. When an encryption key is required to execute the encryption algorithm, the encryption processing unit 206 retrieves a predetermined encryption key from an encryption database 232 and performs the encryption and decryption.

A central processing unit 200 has a central processor and a process operating memory installed with an Operating System (OS) and a main program, thus controlling the function units and executing the entire flow of the electronic payment.

In the meantime, the electronic payment server stores various databases in a predetermined memory and uses the databases for the provision of an electronic payment service. Theses databases are described below.

An electronic slip database 220 is used to store the contents of a certain electronic slip after the electronic slip generated for each transaction has been transmitted to the user. The stored electronic slip can be used later to ascertain the issue details of the electronic slip.

A user database 222 is used to store the information of customers (users) wanting to use the real time electronic slip payment service of the present invention, and is a place where member information, which was input by users wanting to use the service of the present invention, is stored at the time of member registration. The member information includes a user's name, resident registration number (or social security registration number), ID, password, mobile communication terminal number and electronic signature. The electronic signature is used to determine, at the time of electronic payment, whether an electronic signature, which is affixed to the signature item of the approved electronic slip received from the user, is genuine. Further, the mobile communication terminal number refers to the unique identification number of each user's own mobile phone (cellular phone, PCS phone, GPS phone, etc.), PDA, etc.

An affiliate shop database 224 is used to store the information of each affiliate shop participating in the real time electronic slip payment service of the present invention, and includes an affiliate shop name, a business registration number, a representative's name and resident registration number (or social security registration number), an ID, a password, and the unique number of an affiliate shop terminal. The unique terminal number refers to one of the numbers of all wired/wireless communication devices capable of notifying the electronic payment server of transaction details or receiving payment details from the electronic payment server, such as wired/wireless phone numbers, a fax number and an email address.

A user account database 226 is used to store the financial information of the user, such as a user name, a bank and a transfer account number or a credit card number to be used for payment, and loan/deposit transactions, with respect to each user. The electronic slip processing unit retrieves the account information of the corresponding user from the user account database, constructs an account list in the transfer account selection item of the electronic slip and transmits the electronic slip to the user.

An affiliate shop account database 228 is used to store the information of the deposit account of the affiliate shop, such as a shop name (or representative's name), a business registration number (or resident registration number), and a bank and a deposit account number to which a payment amount is to be transferred, with respect to each affiliate shop. When receiving the approved electronic slip from the user, the electronic payment server transfers a predetermined payment amount from a transfer account selected by the user to the deposit account of the affiliate shop stored in the deposit account database.

A payment detail database 230 is used to store payment details, such as a transaction date, a transaction amount, a user and an affiliate shop that are transaction parties, a transfer account used for payment, and the deposit account of the affiliate shop to which the payment amount is transferred, with respect to each paid transaction, when the payment of each transaction has been completed using deposit transfer or card payment.

An encryption database 232 is used to store required encryption keys when electronic slip contents, etc. are processed based on predetermined encryption/decryption algorithms.

FIGS. 4 and 5 show examples of electronic payment according to embodiments of the present invention. FIG. 4 shows the embodiment of reference numeral 160 of FIG. 1 in which the conditional transaction subscription processor exists in the user management domain, and FIG. 5 shows the embodiment of reference numeral 170 of FIG. 1 in which the conditional transaction subscription processor exists in the affiliate shop management domain.

To perform the electronic payment shown in FIGS. 4 and 5, the step of taking member registration is performed beforehand. That is, to use electronic payment service, the user 110 performs the step of making a member registration in the electronic payment server 150 and registering basic payment information for electronic payment (user's mobile communication terminal number, user's name, user's resident registration number, unique number of conditional transaction subscription processor, transfer account used for payment, and credit card number list). In the flows of FIGS. 4 and 5, the illustration of the member registration step is omitted for ease of explanation.

The examples of electronic payment are described in detail with reference to the drawings below.

FIG. 4 is a flowchart showing the steps of electronic payment performed when the conditional transaction subscription processor exists within the user management domain.

The user 110 inputs a condition for the occurrence of a transaction to the conditional transaction subscription processor that allows a transaction request to be performed depending on an inventory of commodities existing in a user's own place, such as a warehouse or the like at step S402. The conditional transaction subscription processor 120, which has received the condition for the occurrence of a transaction, stores the condition for the occurrence of a transaction in a specific database, and notifies the electronic payment server 150 of a transaction request when an event fulfilling the condition for the occurrence of a transaction occurs at step S404. That is, the conditional transaction subscription processor 120 monitors an inventory of commodities in real time using sensors or infrared detection waves and notifies the electronic payment server 150 of a corresponding transaction request together with transaction request details when the preset condition for the occurrence of a transaction is fulfilled.

For example, if a transaction for specific commodities is set to occur in the case where an inventory of the specific commodities decreases to 50% or less, a transaction request for an required number of commodities is made to meet an inventory standard of 50% when a corresponding event occurs.

The electronic payment server 150, which has been notified of the occurrence of the transaction request, notifies the user's mobile communication terminal 110 of transaction request details at step S406. The user, who has received the transaction request details, makes a contract for the purchase transaction of corresponding commodities with the affiliate shop 130 at step S408. The affiliate shop 130, which has made the transaction contract, requests payment for the transaction of the commodities from the electronic payment server 150 at step S410. The electronic payment server 150, which has received the request, generates an electronic slip including a signature item, a transfer account selection item and transaction details, stores the electronic slip in the electronic slip database, and transmits the generated electronic slip to the user's mobile communication terminal at step S412. The user, who has receiving the electronic slip, returns an approved electronic slip, which is generated by affixing the user's signature to the signature item within the electronic slip using electronic signature and selecting an account for payment, to the electronic payment server at step S414. The approved electronic slip includes information about the position value of the user's mobile communication terminal.

The electronic payment server 150, which has received the approved electronic slip, makes payment transfer by requesting the financial institution's server to draw a transaction amount from the transfer account indicated on the approved electronic slip and transferring the transaction amount to the affiliate shop's deposit account at steps S416 and S418. When the electronic payment server 150 is notified of the completion of transfer from the financial institution's server at step S418, the electronic payment server 150 stores payment details in a payment detail database, thus completing the entire payment process.

FIG. 5 is a flowchart showing the steps of the electronic payment of reference numeral 170 of FIG. 1 performed when the conditional transaction subscription processor exists within the affiliate shop management domain.

The commodities that the conditional transaction subscription processor handles within the affiliate shop domain are related to intangible transactions, such as stock trading, foreign exchange trading, flight ticket reservation and hotel reservation, unlike the case where a transaction request is made depending on the user's inventory as shown in FIG. 4.

The flow of FIG. 5 is described below. The user accesses an affiliate shop's web site via the Internet, logs in to a specific host of the affiliate shop, and then inputs a specific condition for the occurrence of a transaction to the conditional transaction subscription server at step S502. The user can change the input and then input a new condition for the occurrence of a transaction before the previously set condition is fulfilled.

The conditional transaction subscription processor 120 attached to the above specific host of the affiliate shop having received the condition for the occurrence of a transaction monitors whether the condition for the occurrence of a transaction is fulfilled in real time, and notifies the electronic payment server 150 of the occurrence of the transaction when the preset condition for the occurrence of the transaction is fulfilled at step S504.

For example, if the user has input the condition for the occurrence of a transaction in which the 100 stocks of a specific company are purchased the following day when the stocks of the specific company reach their lower limit price one day, the conditional transaction subscription server transmits transaction occurrence notice that the conditional transaction subscription server is to purchase 100 stocks at the lower limit price the following day, to the electronic payment server 150.

The electronic payment server 150, which has received the notice, generates an electronic slip including transaction occurrence details, a signature item and a transfer account selection item, and transmits the electronic slip to the electronic payment server. The user generates an approved electronic slip by affixing a signature, such as an electronic signature, to the received electronic slip and selecting a transfer account for payment, and returns the approved electronic slip to the electronic payment server at step S508. The electronic slip includes information about the position value of the user's mobile communication terminal. In this case, the electronic payment server 150, which has received the approved electronic slip, completes transfer by requesting a financial institution to make a transfer from the corresponding transfer account to the affiliate shop's deposit account at steps S510 and S512. Thereafter, the electronic payment server 150 completes the entire payment process by notifying the affiliate shop and the user of the completion of payment at steps S514a and S514b.

In the meantime, when the embodiment of FIG. 5 is applied to reservation transactions, such as flight ticket reservation and hotel reservation, a virtual deposit account may be used for account transfer. The virtual deposit account refers to a virtual account used when payments are taken from the user's account, temporarily deposited in the virtual account, and transferred to a corresponding affiliate shop's account when the transaction is completely concluded.

Thereafter, if the transaction is concluded without an event, such as abandonment or cancellation, the electronic payment server transfers the payments from the virtual deposit account to the affiliate shop's account. In contrast, if the reservation transaction is cancelled at the user's request after the payments have been transferred to the virtual deposit account, cancellation-related fees are deducted from the payments in the virtual deposit account, the fees are transferred to the affiliate shop's account and the remainder is transferred to the user's account, and the user and the affiliate shop are notified of the money transfer.

Although the present invention has been described in detail based on the preferred embodiments, the above-described embodiments have been disclosed for illustrative purposes, and those skilled in the art will appreciate that various modifications are possible without departing from the technological spirit of the present invention.

### INDUSTRIAL APPLICABILITY

As described above, the present invention provides convenience in that a transaction occurs in real time based on a specific condition for the occurrence of a transaction and payment for the transaction is electronically performed using a mobile communication terminal, so that the user can performs a conditional transaction and payment for the conditional transaction without monitoring the conditional transaction.

1. An electronic payment method based on conditional transaction, comprising:
the member registration step of taking member registration from a user and an affiliate shop who want to make electronic payment;
the conditional transaction subscription notification step of being notified of a transaction request by a conditional transaction subscription processor to which a condition for occurrence of a transaction is input, and notifying a user's mobile communication terminal of details of the transaction request;
the conditional transaction payment request reception step of payment for a transaction being requested by the user, which has been notified of the transaction request, and the affiliate shop, who has performed the transaction;
the electronic slip transmission step of generating an electronic slip, including a transaction detail item for the requested transaction, a signature item for approval, and a transfer account selection item for payment, and transmitting the electronic slip to a user's mobile communication terminal;
the approved electronic slip reception step of receiving an approved electronic slip, including a signature item, to which an approval indication is affixed, and a transfer account item, on which a transfer account used for payment is indicated, from the user's mobile communication terminal;
the payment step of performing transfer of payments by requesting the transfer of payments from the transfer account indicated on the transfer account item of the approved electronic slip to an affiliate shop's deposit account from a financial institution's server; and
the payment completion notification step of notifying the user and the affiliate shop of completion of the payment, together with payment details, after completion of the transfer.

2. The method according to claim 1, wherein, at the conditional transaction subscription notification step, the conditional transaction subscription processor ascertains a number of a specific kind of commodities within a user management domain, and requests payment for the transaction from the electronic payment server when the specific condition for the occurrence of the transaction is fulfilled.

3. An electronic payment method based on conditional transaction, comprising:
the member registration step of taking member registration from a user and an affiliate shop who want to make electronic payment;
the conditional transaction payment request reception step of being notified of a payment request for a corresponding transaction by a conditional transaction subscription processor, to which a condition for occurrence of a transaction is input, when the condition is fulfilled;
the electronic slip transmission step of generating an electronic slip, including a transaction detail item for the requested transaction, a signature item for approval, and a transfer account selection item for payment, and transmitting the electronic slip to a user's mobile communication terminal;
the approved electronic slip reception step of receiving an approved electronic slip, including a signature item, to which an approval indication is affixed, and a transfer account item, on which a transfer account used for payment is indicated, from the user's mobile communication terminal;
the payment step of performing transfer of payments by requesting the transfer of payments from the transfer account indicated on the transfer account item of the approved electronic slip to an affiliate shop's deposit account from a financial institution's server; and
the payment completion notification step of notifying the user and the affiliate shop of completion of the payment, together with payment details, after completion of the transfer.

4. The method according to claim 1, wherein the transfer of payments of the payment step comprises:
the first step of transferring the payments from the transfer account indicated on the transfer account item to a virtual deposit account;
the second step of, after a reservation transaction has been completed, transferring the payments from the virtual deposit account to the affiliate shop's deposit account; and
the third step of, if the reservation transaction is cancelled, deducting cancellation-related fees from the payments deposited in the virtual deposit account, transferring the fees to the affiliate shop's account, transferring a remainder to the user's transfer account, and notifying the user and the affiliate shop of the money transfer.

5. The method according to claim 3, wherein, at the conditional transaction subscription reception step, the conditional transaction subscription processor ascertains transaction status of a tangible/intangible commodity or a service within an affiliate shop management domain, and requests payment for the transaction from the electronic payment server when the specific condition for the occurrence of the transaction is fulfilled.

6. The method according to claim 1, wherein, at the conditional transaction request reception step, a number of the user's mobile communication terminal to be used for payment, a name of a commodity related to the transaction, a name of the affiliate shop and an amount of the payments are transmitted.

7. The method according to claim 1, wherein the approved electronic slip includes information about a position value of the user's mobile communication terminal.

8. An electronic payment server for performing electronic payment with a user's mobile communication terminal and an affiliate shop's terminal mounted with a conditional transaction subscription processor using an electronic slip, comprising:
a network interface unit for performing data exchange with the user's mobile communication terminal and the affiliate shop's terminal via wired/wireless networks;
an electronic slip processing unit for generating, managing and storing the electronic slip including transaction details, a signature item representing a transaction approval indication, and a transfer account item;
an encryption processing unit for encrypting/decrypting data to be transmitted and received through the wired/wireless networks based on a predetermined encryption algorithm;
a central processing unit installed with an Operating System (OS) to control a flow of the electronic payment by controlling the function units; and
a database unit for storing information and data required to perform the electronic payment.

9. The electronic payment server according to claim 8, wherein the database unit comprises:
an electronic slip database for storing the electronic slip generated by the electronic slip processing unit;
a user database for storing personal information of the user wanting to make the electronic payment;
an affiliate shop database for storing shop information of the affiliate shop wanting to make the electronic payment;
a user account database for storing personal transfer account numbers and credit card numbers to be used for the electronic payment with respect to each user;
an affiliate shop account database for storing a deposit account, to which a payment amount is to be transferred from the transfer account of the user based on the electronic payment, with respect to each affiliate shop;
a payment detail database for storing corresponding payment details with respect to each transaction for which electronic payment is completed; and
an encryption database for storing encryption keys required for a predetermined encryption algorithm.
